(19) United States
(12) Patent Application Publication
(10) Pub. No.: US 2002/0002545 A1
(43) Pub. Date: Jan. 3, 2002

(54) Electronic money transaction device and method

(76) Inventor: James D. Resneck, Palo Alto, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/886,357

(22) Filed: Jun. 20, 2001

Related U.S. Application Data
(60) Provisional application No. 60/215,181, filed on Jun. 29, 2000.

(51) Int. Cl. G06F 17/60

(52) U.S. Cl. 705/74; 705/26

(57) ABSTRACT

Embodiments of the present invention are directed to methods, systems, and devices for performing transactions via a communications network such as the Internet while preserving the anonymity of at least one of the parties. A transaction device is linked to an anonymous account to allow a party to preserve an equivalent level of anonymity as the use of cash when making a transaction at a traditional brick-and-mortar business as well as in the virtual world of electronic commerce. As such, the transaction device may be considered equivalent to a flexible and versatile cash wallet. In this way, the present invention combines the desirable features of cash (anonymity, security, and acceptance) and of electronic commerce (speed, ease, and convenience). To preserve secrecy of the shipping address, anonymous address information is provided to the merchant for sending an item to an address associated with the anonymous address information. The anonymous address information includes a carrier name of a carrier and an anonymous address identification code. The carrier is provided with the anonymous address identification code and the address associated therewith. The merchant does not have access to the address.

This application is based on and claims the benefit of U.S. Provisional patent application Ser. No. 60/215,181, filed Jun. 29, 2000, the entire disclosure of which is incorporated herein by reference.

### BACKGROUND OF THE INVENTION

This invention relates to methods, systems, and devices for performing transactions via a communications network such as the Internet. More particularly, the invention facilitates transactions between parties using an anonymous account to preserve the anonymity of one of the parties.

As a result of the increasing role of the Internet in our lives in this modern, post-industrial, information era, there has been increasing concern by growing segments of the society regarding how widely personal information is disseminated. This trend appears to be accelerating. For instance, when one uses personal credit card for purchases via the Internet, the information may be collected by marketing analysts and data miners to create a personal profile of the user. Those who desire to preserve the quality or state of being unknown or unacknowledged choose to keep their purchases local to preserve their anonymity. Concerns about privacy have led many to refrain from engaging in transactions over the Internet.

A truly anonymous purchase is one in which the purchaser and seller are unknown to each other, the purchase process is not witnessed by any other person, and the exchange medium is cash. Such transactions are not the norm. Even cash transactions in a place of business is typically witnessed by salespersons and other customers or bystanders, if not recorded on videotape as a routine security measure. On the other hand, common transaction media such as payment by personal check or credit card represent a clear loss of anonymity, since the purchaser's identity as well as other personal information is attached to the transaction (e.g., driver's license number, address, telephone number, and any information attached to the name, credit card, or driver's license number). Thus, although a cash transaction is not a truly anonymous purchase, it provides a considerably higher degree of purchase anonymity than a transaction involving a personal check or credit card, and affords perhaps the highest degree of purchase anonymity achievable in the present. The use of cash, however, has limitations, especially in the context of electronic commerce.

### SUMMARY OF THE INVENTION

Embodiments of the present invention are directed to methods, systems, and devices for performing transactions via a communications network such as the Internet while preserving the anonymity of at least one of the parties. A transaction device is linked to an anonymous account to allow a party to preserve an equivalent level of anonymity as the use of cash when making a transaction at a traditional brick-and-mortar business as well as in the virtual world of electronic commerce. As such, the transaction device may be considered equivalent to a flexible and versatile cash wallet. In this way, the present invention combines the desirable features of cash (anonymity, security, and acceptance) and of electronic commerce (speed, ease, and convenience).

An aspect of the present invention is directed to a method of facilitating transaction between a first party and a second party using an anonymous account. The method comprises receiving anonymous account access information from a portable transaction device having at least one storage medium containing the anonymous account access information for accessing an anonymous account. The anonymous account access information on the at least one storage medium is readable by at least one of an optical data reader, a magnetic data reader, and an electronic data reader. The method further comprises transmitting the anonymous account access information on the at least one storage medium of the portable transaction device, via a communications network, to access the anonymous account and to transfer funds between the anonymous account and an account of the second party. The anonymous account is held by a third party not directly associated with the first party and the first party's personal accounts.

In some embodiments, the at least one storage medium comprises one or more of a CD-ROM, a magnetic strip, and a bar code, each containing the anonymous account access information. The method may include transmitting an identification code to authenticate the transfer of funds between the anonymous account and the account of the second party. The second party may be a point-of-sale merchant and the anonymous account access information is read by a reader at the point of sale. The second party may be an online merchant and the anonymous account access information is read by an electronic data reader of a computer. The second party may be a holder of the first party's personal account. Transmitting the anonymous account access information may comprise transferring encrypted data via the communications network.

In some embodiments, the method includes providing anonymous address information to the second party for sending an item to an address associated with the anonymous address information. The anonymous address information includes a carrier name of a carrier and an anonymous address identification code. The carrier is provided with the anonymous address identification code and the address associated therewith.

Another aspect of the invention is directed to a method of preserving anonymity of a first party in a transaction with a second party. The method comprises receiving anonymous account access information from a portable transaction device having at least one storage medium containing the anonymous account access information for accessing an anonymous account. The method further comprises transmitting the anonymous account access information on the at least one storage medium of the portable transaction device, via a communications network, to access the anonymous account and to transfer funds between the anonymous account and the second party. The anonymous account is held by a third party not directly associated with the first party and the first party's personal accounts. Anonymous address information is provided to the second party for sending an item to an address associated with the anonymous address information.

In some embodiments, the anonymous address information includes a carrier name of a carrier and an anonymous address identification code. The carrier may have the anonymous address identification code and the address associated therewith. The anonymous address identification code may be contained in a bar code provided on an anonymous address label to be affixed to the item to be sent. The method may include providing the carrier with the anonymous address identification code and the address associated therewith. The anonymous address information may include a parcel identification number associated with the item to be sent.

Another aspect of the present invention is directed to a method of facilitating transaction between a first party and a second party using an anonymous account. The method comprises receiving, via a communications network, anonymous account access information from a portable transaction device having at least one storage medium containing the anonymous account access information for accessing an anonymous account. The anonymous account access information on the at least one storage medium is readable by at least one of an optical data reader, a magnetic data reader, and an electronic data reader. The method further comprises accessing the anonymous account, based on the anonymous account access information on the at least one storage medium of the portable transaction device, to transfer funds between the anonymous account and an account of the second party. The anonymous account is held by a third party not directly associated with the first party and the first party's personal accounts.

Another aspect of the invention is directed to a data processing system for facilitating transaction between a first party and a second party while preserving anonymity of the first party. The system comprises a processor and a memory coupled to the processor. The memory is configured to store a plurality of code modules for execution by the processor. The plurality of code modules comprise a first code module for receiving anonymous account access information from a portable transaction device having at least one storage medium containing the anonymous account access information for accessing an anonymous account. The anonymous account access information on the at least one storage medium is readable by at least one of an optical data reader, a magnetic data reader, and an electronic data reader. A second code module is provided for transmitting the anonymous account access information on the at least one storage medium of the portable transaction device, via a communications network, to access the anonymous account and to transfer funds between the anonymous account and an account of the second party. The anonymous account is held by a third party not directly associated with the first party and the first party's personal accounts.

In some embodiments, a third code module is provided for transmitting an identification code to authenticate the transfer of funds between the anonymous account and the second party. A fourth code module is provided for providing anonymous address information to the second party for sending an item to an address associated with the anonymous address information. A fifth code module is provided for providing a carrier with the anonymous address identification code and the address associated therewith.

Another aspect of the present invention is directed to a computer program product stored on a computer-readable storage medium for facilitating transaction between a first party and a second party while preserving anonymity of the first party. The computer program product comprises code for receiving anonymous account access information from a portable transaction device having at least one storage medium containing the anonymous account access information for accessing an anonymous account. The anonymous account access information on the at least one storage medium is readable by at least one of an optical data reader, a magnetic data reader, and an electronic data reader. Code is provided for transmitting the anonymous account access information on the at least one storage medium of the portable transaction device, via a communications network, to access the anonymous account and to transfer funds between the anonymous account and an account of the second party. The anonymous account is held by a third party not directly associated with the first party and the first party's personal accounts.

In some embodiments, the computer program product further comprises code for transmitting an identification code to authenticate the transfer of funds between the anonymous account and the second party. The product may include code for providing anonymous address information to the second party for sending an item to an address associated with the anonymous address information. The product may include code for providing a carrier with the anonymous address identification code and the address associated therewith.

In accordance with another aspect of the present invention, a system for facilitating transaction between a first party and a second party while preserving anonymity of the first party comprises a communications network. A merchant system is coupled to the communications network and configured to provide access to a merchant account. An anonymous account holding institution system is coupled to the communications network and configured to provide access to an anonymous account. A user system is coupled to the communications network and configured to communicate anonymous account access information to the anonymous account holding institution system to access the anonymous account and transfer funds between the anonymous account and the merchant account. The anonymous account is held by a third party not directly associated with a user providing the anonymous account access information.

In some embodiments, the user system is configured to communicate an identification code to authenticate the transfer of funds between the anonymous account and the merchant account. The user system is configured to communicate anonymous address information to the merchant system for sending an item to an address associated with the anonymous address information. A shipping carrier system is coupled to the communications network and configured to receive from the user system the anonymous address information and the address associated therewith. The user system and the merchant system may be comprised of a single point-of-sale system provided by a point-of-sale merchant.

### BRIEF DESCRIPTION OF THE DRAWINGS

FIG. 1 is an elevational view of a transaction device in accordance with an embodiment of the present invention;

FIG. 2 is a schematic diagram depicting a system for utilizing the transaction device for anonymous transactions according to an embodiment of the invention;

FIG. 3 is a flow diagram illustrating initial purchase and funding of the transaction device according to an embodiment of the invention;

FIG. 4 is a flow diagram illustrating the use of the transaction device for in-store purchase according to an embodiment of the invention;

FIG. 5 is a flow diagram illustrating the use of the transaction device for online purchase according to an embodiment of the invention;

FIG. 6 is a flow diagram illustrating anonymous and non-anonymous mailing instructions for shipping merchandise associated with the online purchase according to an embodiment of the invention; and

FIG. 7 is a block diagram of an anonymous transaction device computer or machine in accordance with an embodiment of the present invention.

### DESCRIPTION OF THE SPECIFIC EMBODIMENTS

I. Transaction Device

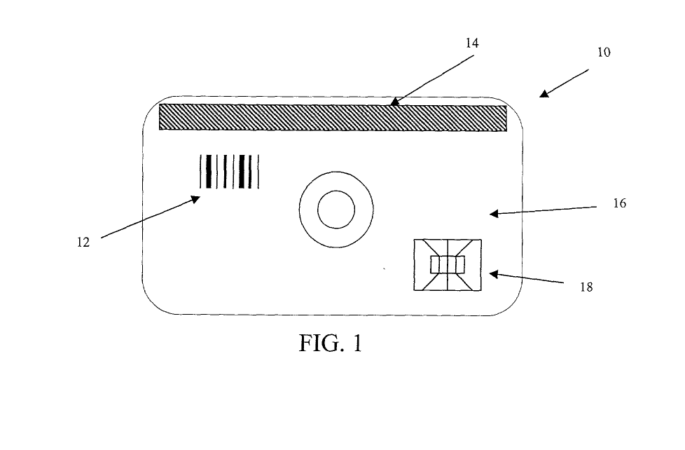

As shown in FIG. 1, a portable transaction device 10 is conveniently configured to be the size of a credit card that can fit easily into a pocket, a wallet, or a purse. The transaction device 10 has at least one, preferably more than one, storage medium for storing account access information that can be read by a reading device for accessing an anonymous account. For instance, the transaction device 10 includes one or more of a bar code 12, a magnetic strip 14, a CD-ROM 16, a smart-card microprocessor 18 which may be provided with digital storage, and the like. The different storage media on the device 10 may contain the same or different information. The body of the transaction device 10 as shown is a shaped CR-ROM 16. The CD-ROM 16 may be a write-once read-only CD-R. The reading device for reading information stored in the storage media may be an optical scanner, a magnetic data reader, an electronic data reader, or the like. As such, the device 10 may be used in traditional brick-and-mortar establishments as well as in the virtual world of electronic commerce.

II. System for Anonymous Transaction

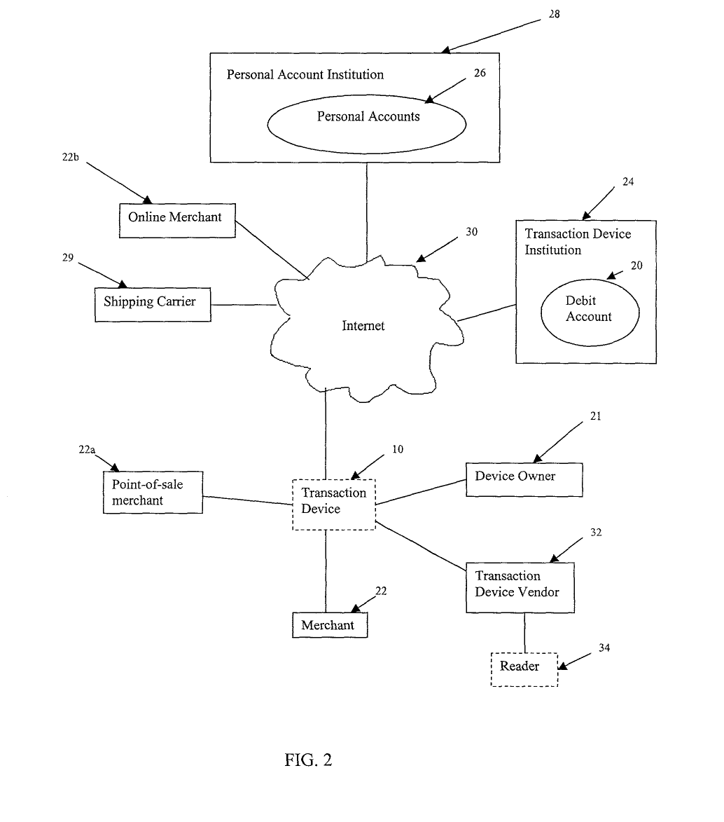

As illustrated in FIG. 2, the transaction device 10 is linked to a debit account 20 having a debit limit. The owner 21 (first party) of the transaction device 10 can use the transaction device 10 to make purchases or conduct a transaction with a second party 22 up to the debit limit of the debit account 20. FIG. 2 shows a number of such second parties 22 which may include point-of-sale merchants 22a, online merchants 22b, and the like. The debit account 20 is held by the transaction device company or institution 24. In one preferred embodiment, the debit account 20 is an anonymous account held by a third party bank or institution 24 which is not directly associated with the device owner's personal accounts 26 (e.g., savings, checking, and other financial accounts) held by a personal accounts institution 28. In this way, the personal information of the device owner may be concealed from the second party 22 (although the identity of the device owner may be considered disclosed if the second party 22 is a point-of-sale merchant 22a). FIG. 2 further shows a shipping carrier 29 for shipping merchandise purchased from the online merchant 22b.

The communication among the various parties shown in FIG. 2 may be facilitated by a communications network such as the Internet 30. Access to the Internet 30 by the different parties may be made via computers or systems provided at the device owner 21 (user system), the merchants 22, 22a, 22b (merchant system), the transaction device or anonymous account holding institution 24 (anonymous account holding institution system), personal accounts institution 28 (personal accounts institution system), and shipping carrier 29 (shipping carrier system). The merchant system is configured to provide access to the merchant account. The anonymous account holding institution system is configured to provide access to the anonymous account 20. The user system is configured to communicate anonymous account access information to the anonymous account holding institution system to access the anonymous account and transfer funds between the anonymous account and the merchant account. The shipping carrier system is configured to receive from the user system the anonymous address information and the address associated therewith.

In the case of a point-of-sale merchant 22a, the computer system provided at the point-of-sale serves as both a user system (by reading the transaction device 10 and communicating the anonymous account access information) and a merchant system (by providing access to the merchant account).

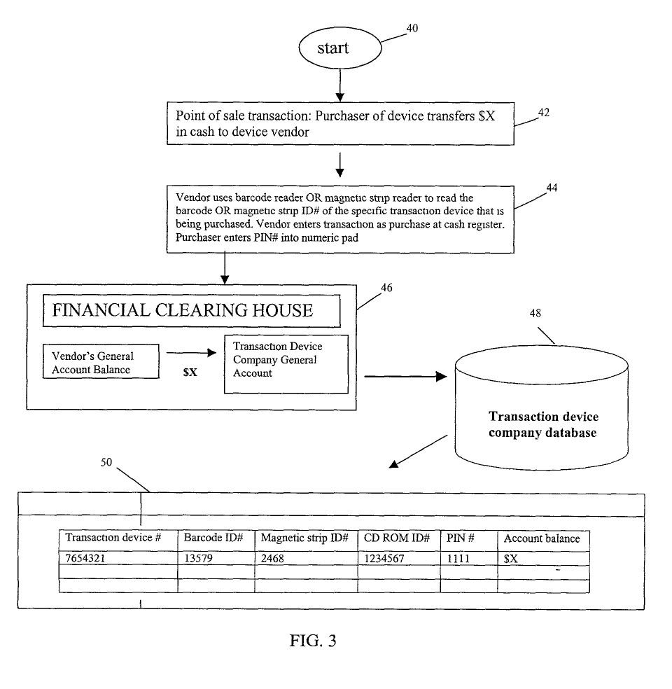

The transaction device 10 may be purchased from a variety of entities or vendors. FIG. 3 shows a flow diagram illustrating the purchase and activation of the device 10 according to an embodiment of the invention. Advantageously, the transaction device 10 may be purchased from and funded at a vendor 32 (see FIG. 2). The vendor 32 may be one of the merchants 22. At the start 40, the customer goes to a vendor 32 who sells such devices. The customer pays the vendor 32 by cash, check, credit card, or the like, and the vendor 32 funds the debit account 20 with the payment by the customer-owner, for instance, via an electronic fund transfer (EFT) to the debit account holding entity 24 (step 42). The use of cash may be desirable to preserve anonymity. The information of the debit account 20 is provided in any of the storage media provided on the device 10 as shown in FIG. 1 and described above. The vendor 32 reads the account information using a suitable reader 34 (e.g., a bar code reader for reading a bar code or a magnetic reader for reading a magnetic strip). The device 10 is activated and funded at the point-of-sale (step 44). Alternatively, the debit account 20 may be funded by the device owner's personal accounts 26 or any other account by EFT. The debit account 20 remains anonymous so that the transaction device 10 has the anonymity of cash.

In some embodiments, an identification or authentication code similar to a personal identification number (PIN) used for debit cards and credit cards is required with the use of the transaction device 10 to authenticate the transfer of funds to and/or from the debit account 20. The identification code can be assigned to the device 10 or selected by the owner who enters it on a number pad at the time of purchase of the device 10 (step 44).

As shown in FIG. 3, $X is transferred from the vendor's general account to the general account of the transaction device company 24 (see 46). The record of the transaction device 10 is stored in the database 48 of the transaction device company 24. The record 50 contains information such as the account number or identification number of the device 10, bar code ID number, magnetic strip ID number, CD-ROM ID number, personal identification number, and account balance. In the example shown, the different ID numbers (for the bar code, magnetic strip, and CD-ROM) are different, but provide access to the same debit account 20. These different ID number are “dummy” account numbers that would render forgery of the device unlikely.

III. Anonymous Transaction Process

Upon activation, the transaction device 10 is ready for use in traditional brick-and-mortar establishments as well as in electronic commerce by accessing the debit account 20 through the device 10 using a reader. The transaction device 10 may be disposed after one or more uses. Alternatively, the debit account 20 can be replenished to enable the transaction device 10 to be used repeatedly as a debit card or electronic wallet. This can be done at a vendor 32, a point-of-sale merchant 22a, via EFT from the owner's personal accounts 26 or other accounts, or the like.

A. In-Store Purchase

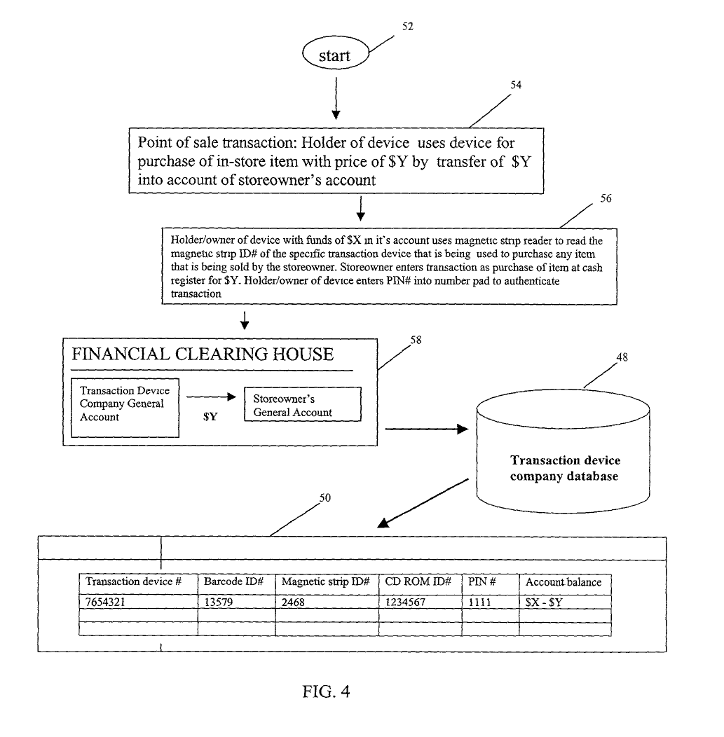

The owner of the transaction device 10 can use the device 10 to make a point-of-sale transaction at a brick-and-mortar establishment at the start 52, as shown in FIG. 4. The transaction device 10 allows fund transfer from the anonymous account 20 to the account of the point-of-sale merchant 22a (see 54). The device 10 is read, typically using a magnetic strip reader, by the point-of-sale merchant. If an identification code is required, the device owner enters the code into a number pad to authenticate the transaction (step 56).

Provided sufficient funds are available in the debit account 20, $Y is transferred from the general account of the transaction device company 24 to the merchant's general account (see 58). The record 50 of the transaction device 10 as stored in the database 48 of the transaction device company 24 is modified by subtracting $Y from $X. Because the transaction device holding institution 24 is not directly associated with the device owner's personal accounts, the transaction is completed without disclosing any personal information of the device owner to the merchant 22a.

B. Online Purchase

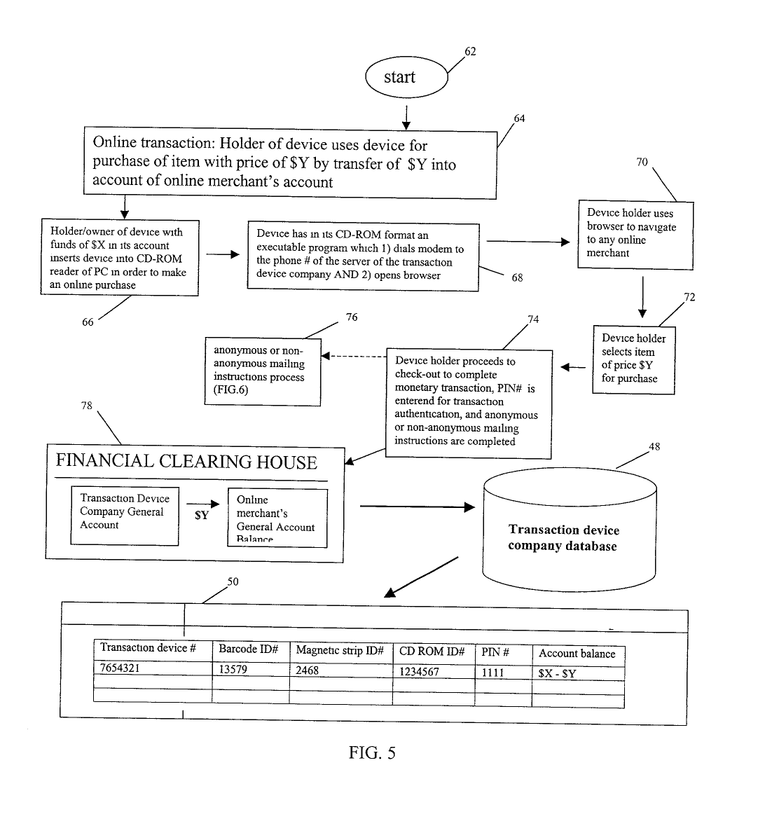

FIG. 5 shows the use of the transaction device 10 in an online transaction by accessing the online merchant via a communications network such as the Internet at the start 62. The transaction device 10 allows fund transfer from the anonymous account 20 to the account of the online merchant 22b (see 64). The device 10 is read by inserting it into a computer such as a PC with a CD-ROM reader (step 66). In a preferred embodiment, the CD-ROM 16 of the device 10 contains a computer executable program that dials the telephone number of the server of the transaction device institution 24 via the modem of the computer, enters the URL of the institution 24, and opens the Web browser (step 68). From this Internet portal, the device owner uses the Web browser to navigate to a desired online merchant (step 70), and to select one or more items for purchase at $Y (step 72). At step 74, the device owner proceeds to check-out to complete the transaction. If an identification code is required, the device owner enters the code using a number pad to authenticate the transaction (step 74). The device owner also provides mailing instructions for shipping the selected merchandise, which may be anonymous or non-anonymous. The mailing instruction process (step 76) is described in more detail below.

Provided sufficient funds are available in the debit account 20, $Y is transferred from the general account of the transaction device company 24 to the online merchant's general account (see 78). The record 50 of the transaction device 10 as stored in the database 48 of the transaction device company 24 is modified by subtracting $Y from $X. Because the transaction device holding institution 24 is not directly associated with the device owner's personal accounts, the money transfer is completed without disclosing any personal information of the device owner to the online merchant. The use of anonymous mailing instructions may further protect the device owner's anonymity by concealing the shipping address from the online merchant 22b.

For security purposes, all data transfer is desirably conducted via secured networks with appropriate data encryption.

C. Anonymous and Non-anonymous Mailing Instructions

For transactions involving shipping, the device owner has the option of selecting anonymous mailing instructions to conceal the shipping address from the merchant or non-anonymous mailing instructions when the secrecy of the shipping address need not be preserved. The mailing instructions are conveniently separated or decoupled from the money transaction. If the shipping address belongs to the device owner, using the anonymous mailing instruction will protect the device owner's anonymity by concealing the address. If a different shipping address not directly associated with the device owner is used, it may not be necessary to conceal it to protect the device owner's anonymity. In some cases, it may be desirable to protect the addressee's anonymity even if it is not directly associated with the device owner. The present invention provides the options for doing so. The following describes an embodiment of the process in the context of an online purchase, but the process may be used for shipping merchandise by point-of-sale merchants as well.

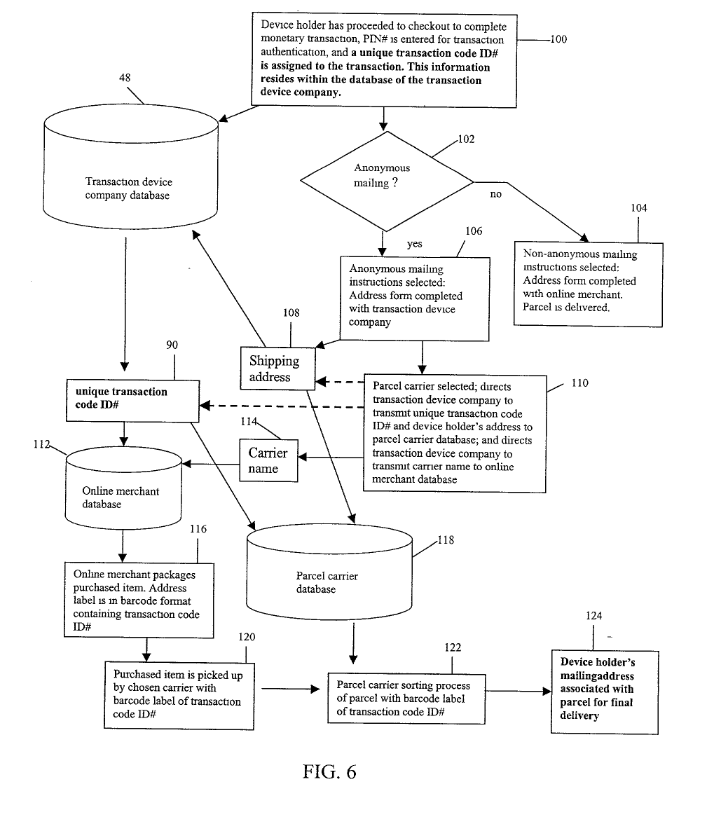

As shown in FIG. 6, a transaction code identification number (ID#) 90 is assigned to the transaction (FIG. 5) upon completion of the purchase transaction at check-out, and optionally authentication using an identification number (step 100). The transaction code ID# 90 resides within the database 48 of the transaction device company 24.

Meanwhile, the device owner is prompted to select either anonymous or non-anonymous mailing instructions in step 102. If the owner selects non-anonymous mailing, an address form is displayed. The address form is typically provided by the online merchant at its website. The owner fills out the address form and the information is transmitted to the online merchant to be used for shipping the purchased merchandise (step 104).

If the owner selects anonymous mailing, an address form is displayed. The address form is typically provided by the transaction device company 24 at its website. The owner fills out the address form and the information is transmitted to the transaction device company 24 and stored in the database 48 (step 106). The shipping address 108 may be the device owner's address or another address. In step 110, the owner is also prompted to select a shipping or parcel carrier 29 (see FIG. 2). The transaction device company 24 is instructed to transmit the transaction code ID# 90 to the online merchant database 112. The chosen shipping carrier name 114 is transmitted to the online merchant database 112. The online merchant packages the purchased item, and prints an anonymous address label in bar code format or other coded format containing the transaction code ID# 90 (step 1 16). The bar code may include a field for the chosen shipping carrier name 114. Meanwhile, the transaction device company 24 is instructed to transmit the transaction code ID# 90 and the associated shipping address 108 to the chosen shipping carrier database 118.

As shown in FIG. 6, the packaged item with the coded address label is picked up by the chosen carrier (step 120) and is sorted by the shipping carrier at its distribution center. More particularly, the shipping carrier reads the transaction code ID# 90 on the packaged item and matches the shipping address 108 with the transaction code ID# 90 using the data stored in the database 118 (step 122). The carrier then delivers the packaged item to the shipping address 108 associated with the transaction code ID# 90 (step 124). The carrier may print a traditional address label and attach it to the packaged item, or retain the coded address label with the transaction code ID# 90 serving as a parcel identification number with an associated shipping address for the delivery to the proper shipping address. Because the shipping address 108 is concealed from the online merchant 22b, anonymity of the addressee is preserved.

V. Anonymous Transaction Machine

The anonymous transaction process is encoded in computer software and executed in a computer device. The computer device may be provided at the transaction device institution 24, or at any of the merchants 22, 22a, 22b shown in FIG. 2, or at a separate anonymous transaction server which is in communication with the rest of the system of FIG. 2 via the Internet 30 or other communications network.

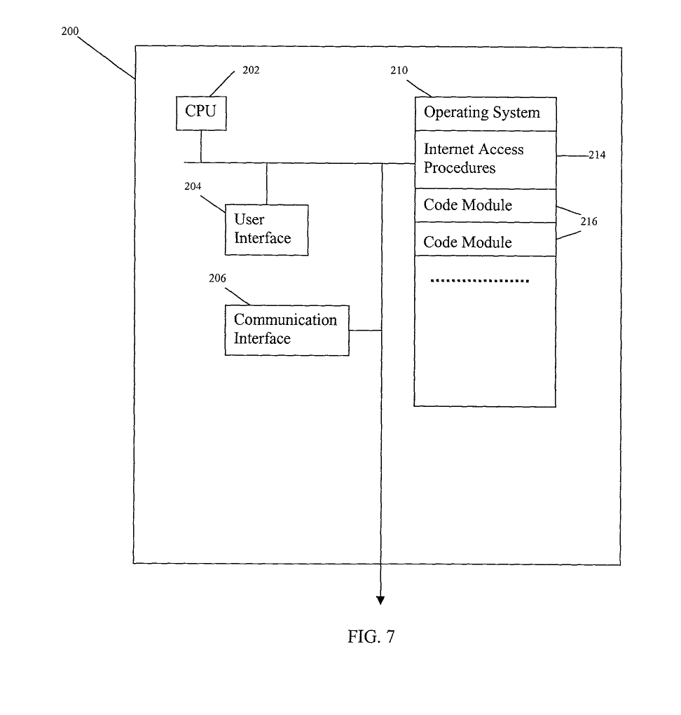

FIG. 7 shows an anonymous transaction device computer or machine 200, which can be any type of computing device, such as a desktop computer, a workstation, or a mainframe computer. The anonymous transaction machine 200 includes a CPU 202, a user interface 204, a communications interface 206, and a memory 210. The communications interface 206 is used to communicate with the other parties in the system of FIG. 2 as well as other system sources not shown. The memory 210 may be implemented as RAM (random access memory) or other types of memory. The memory 210 contains data, procedures, files, and other information used to perform the functions of the anonymous transaction machine 200. The memory 210 may contain an operating system 212, Internet access procedures 214, code modules 216 for carrying out various processes described above, and the like. For instance, different code modules 216 may be used to store instructions for performing the initial purchase and funding of the transaction device of FIG. 3, the use of the transaction device for in-store and online purchases as shown in FIGS. 4 and 5, and the anonymous and non-anonymous mailing instructions for shipping merchandise as shown in FIG. 6.

V. Alternative Embodiments

The above-described arrangements of apparatus and methods are merely illustrative of applications of the principles of this invention and many other embodiments and modifications may be made without departing from the spirit and scope of the invention as defined in the claims.

The CD-ROM 16 of the transaction device 10 as described above is programmed to direct the user of the transaction device 10 to the URL of the transaction device company 24 which holds the anonymous debit account 20, and open the Web browser. In other embodiments, the CD-ROM 16 may be programmed to direct the user to any URL desired, such as the home page of a company that sells the transaction device 10. As such, the transaction device 10 may serve as an electronic money gift certificate.

Moreover, the CD-ROM 16 may take the form of a write-once read-only CD-R. When the transaction device 10 is placed into a CD writer, a copy of the transactions is written onto the device 10. The device 10 can be used to keep track of the transactions, and serves a purpose different from the anonymous money transactions described above. For instance, such a device 10 can be used as a petty cash account management tool to keep a record of the purchases that is a duplicate of the information for the device 10 in the database of the transaction device debit account holding company 24.

Another example of a transaction not involving money transfer in which anonymity is desired only as an endpoint is a ballot. In that case, the magnetic strip on the ballot device may designate the individual entitled to vote, and the CD-ROM or CD-R portion of the ballot device may be the site at which the voting data is stored. When the ballot device is turned in at the polling place to have the vote counted, the owner's use of the ballot device may be authenticated (e.g., using an identification card). The data on the magnetic strip may then be erased to preserve the anonymity of the vote that is recorded onto the CD-R. This type of record may be preserved for each voter such that a reliable recount can be made, if necessary. The ballot device may be reusable. For instance, the vote may be written to a different location on the CD-R in the next election, and the magnetic strip may be reformatted to the next voter.

The scope of the invention should, therefore, be determined not with reference to the above description, but instead should be determined with reference to the appended claims along with their full scope of equivalents.

What is claimed is:

1. A method of facilitating transaction between a first party and a second party using an anonymous account, the method comprising:
receiving anonymous account access information from a portable transaction device having at least one storage medium containing the anonymous account access information for accessing an anonymous account, the anonymous account access information on the at least one storage medium being readable by at least one of an optical data reader, a magnetic data reader, and an electronic data reader; and
transmitting the anonymous account access information on the at least one storage medium of the portable transaction device, via a communications network, to access the anonymous account and to transfer funds between the anonymous account and an account of the second party, the anonymous account being held by a third party not directly associated with the first party and the first party's personal accounts.

2. The method of claim 1 wherein the at least one storage medium comprises a CD-ROM containing the anonymous account access information.

3. The method of claim 2 wherein the at least one storage medium further comprises a magnetic strip containing the anonymous account access information.

4. The method of claim 3 wherein the at least one storage medium further comprises a bar code containing the anonymous account access information.

5. The method of claim 2 wherein the CD-ROM comprises a write-once read-only CD-R.

6. The method of claim 1 further comprising transmitting an identification code to authenticate the transfer of funds between the anonymous account and the account of the second party.

7. The method of claim 1 wherein the second party is a point-of-sale merchant and the anonymous account access information is read by a reader at the point of sale.

8. The method of claim 7 wherein the reader is selected from the group consisting of an optical scanner, a magnetic data reader, and an electronic data reader.

9. The method of claim 1 wherein the second party is an online merchant and the anonymous account access information is read by an electronic data reader of a computer.

10. The method of claim 1 wherein the second party is a holder of the first party's personal account.

11. The method of claim 1 wherein transmitting the anonymous account access information comprises transferring encrypted data via the communications network.

12. The method of claim 1 further comprising providing anonymous address information to the second party for sending an item to an address associated with the anonymous address information.

13. The method of claim 12 wherein the anonymous address information includes a carrier name of a carrier and an anonymous address identification code.

14. The method of claim 13 further comprising providing the carrier with the anonymous address identification code and the address associated therewith.

15. A method of preserving anonymity of a first party in a transaction with a second party, the method comprising:
receiving anonymous account access information from a portable transaction device having at least one storage medium containing the anonymous account access information for accessing an anonymous account;
transmitting the anonymous account access information on the at least one storage medium of the portable transaction device, via a communications network, to access the anonymous account and to transfer funds between the anonymous account and the second party, the anonymous account being held by a third party not directly associated with the first party and the first party's personal accounts; and
providing anonymous address information to the second party for sending an item to an address associated with the anonymous address information.

16. The method of claim 15 wherein the anonymous address information includes a carrier name of a carrier and an anonymous address identification code.

17. The method of claim 16 wherein the carrier has the anonymous address identification code and the address associated therewith.

18. The method of claim 16 wherein the anonymous address identification code is contained in a bar code provided on an anonymous address label to be affixed to the item to be sent.

19. The method of claim 16 further comprising providing the carrier with the anonymous address identification code and the address associated therewith.

20. The method of claim 15 wherein the anonymous address information includes a parcel identification number associated with the item to be sent.

21. The method of claim 15 wherein the portable transaction device includes a plurality of different storage media each containing the anonymous account access information, the anonymous account access information on the plurality of different storage media being readable by different readers.

22. The method of claim 21 wherein the plurality of different storage media are selected from the group consisting of a CD-ROM, a magnetic strip, a bar code, and a smart card microprocessor.

23. The method of claim 15 further comprising transmitting an identification code to authenticate the transfer of funds between the anonymous account and the third party.

24. A method of facilitating transaction between a first party and a second party using an anonymous account, the method comprising:
receiving, via a communications network, anonymous account access information from a portable transaction device having at least one storage medium containing the anonymous account access information for accessing an anonymous account, the anonymous account access information on the at least one storage medium being readable by at least one of an optical data reader, a magnetic data reader, and an electronic data reader; and
accessing the anonymous account, based on the anonymous account access information on the at least one storage medium of the portable transaction device, to transfer funds between the anonymous account and an account of the second party, the anonymous account being held by a third party not directly associated with the first party and the first party's personal accounts.

25. The method of claim 24 wherein the portable transaction device includes a plurality of different storage media each containing the anonymous account access information, the anonymous account access information on the plurality of different storage media being readable by different readers.

26. The method of claim 24 further comprising providing anonymous address information to the second party for sending an item to an address associated with the anonymous address information.

27. The method of claim 26 further comprising providing the carrier with the anonymous address identification code and the address associated therewith.

28. A data processing system for facilitating transaction between a first party and a second party while preserving anonymity of the first party, the system comprising:
a processor;
a memory coupled to the processor, the memory configured to store a plurality of code modules for execution by the processor, the plurality of code modules comprising:
a first code module for receiving anonymous account access information from a portable transaction device having at least one storage medium containing the anonymous account access information for accessing an anonymous account, the anonymous account access information on the at least one storage medium being readable by at least one of an optical data reader, a magnetic data reader, and an electronic data reader; and
a second code module for transmitting the anonymous account access information on the at least one storage medium of the portable transaction device, via a communications network, to access the anonymous account and to transfer funds between the anonymous account and an account of the second party, the anonymous account being held by a third party not directly associated with the first party and the first party's personal accounts.

29. The system of claim 28 wherein the plurality of code modules farther comprise a third code module for transmitting an identification code to authenticate the transfer of funds between the anonymous account and the second party.

30. The system of claim 28 wherein the plurality of code modules further comprise a fourth code module for providing anonymous address information to the second party for sending an item to an address associated with the anonymous address information.

31. The system of claim 30 wherein the anonymous address information includes a carrier name of a carrier and an anonymous address identification code.

32. The system of claim 31 wherein the plurality of code modules further comprise a fifth code module for providing the carrier with the anonymous address identification code and the address associated therewith.

33. A computer program product stored on a computer-readable storage medium for facilitating transaction between a first party and a second party while preserving anonymity of the first party, the computer program product comprising:
code for receiving anonymous account access information from a portable transaction device having at least one storage medium containing the anonymous account access information for accessing an anonymous account, the anonymous account access information on the at least one storage medium being readable by at least one of an optical data reader, a magnetic data reader, and an electronic data reader; and
code for transmitting the anonymous account access information on the at least one storage medium of the portable transaction device, via a communications network, to access the anonymous account and to transfer funds between the anonymous account and an account of the second party, the anonymous account being held by a third party not directly associated with the first party and the first party's personal accounts.

34. The computer program product of claim 33 further comprising code for transmitting an identification code to authenticate the transfer of funds between the anonymous account and the second party.

35. The computer program product of claim 33 further comprising code for providing anonymous address information to the second party for sending an item to an address associated with the anonymous address information.

36. The computer program product of claim 35 wherein the anonymous address information includes a carrier name of a carrier and an anonymous address identification code.

37. The computer program produce of claim 36 further comprising code for providing the carrier with the anonymous address identification code and the address associated therewith.

38. A system for facilitating transaction between a first party and a second party while preserving anonymity of the first party, the system comprising:
a communications network;
a merchant system coupled to the communications network and being configured to provide access to a merchant account;
an anonymous account holding institution system coupled to the communications network and being configured to provide access to an anonymous account;
a user system coupled to the communications network and being configured to communicate anonymous account access information to the anonymous account holding institution system to access the anonymous account and transfer finds between the anonymous account and the merchant account, the anonymous account being held by a third party not directly associated with a user providing the anonymous account access information.

39. The system of claim 38 wherein the user system is configured to communicate an identification code to authenticate the transfer of funds between the anonymous account and the merchant account.

40. The system of claim 38 wherein the user system is configured to communicate anonymous address information to the merchant system for sending an item to an address associated with the anonymous address information.

41. The system of claim 40 further comprising a shipping carrier system coupled to the communications network and being configured to receive from the user system the anonymous address information and the address associated therewith.

42. The system of claim 38 wherein the user system and the merchant system are comprised of a single point-of-sale system provided by a point-of-sale merchant.
